(19) United States
(12) Patent Application Publication
(10) Pub. No.: US 2006/0047699 A1
(43) Pub. Date: Mar. 2, 2006

(54) Visualizing data in visual application design

(75) Inventors: Eran Belinsky, Haifa (IL); Anthony Lindsey, Fuquay Varina, NC (US); Yoav Rubin, Kfar Saba (IL); Netta Shani, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 10/914,953

(22) Filed: Aug. 10, 2004

(51) Int. Cl. G06F 7/00

(52) U.S. Cl. 707/103 Z

(57) ABSTRACT

A method for a visual application creation tool includes having a data source entity type in the tool, having a data link entity type in the tool and having indications of the type of operation to be performed by a data link entity when the data link entity connects a data entity to at least one non-data-source entity. The data link entity is capable of representing an internal part of the non-data-source entity.

### FIELD OF THE INVENTION

The present invention relates to visual application design generally.

### BACKGROUND OF THE INVENTION

Software may be written in many different ways depending on the programmer skills and possibly the platform on which it is to run. Software is often written in one of the many programming languages, like C++ and Java. However, for many programmers, it is easier to write their application using visual application creation tools, such as Visual Basic, which let the developer create application entities using a palette of elements that are dragged to an editor canvas that represents a visual abstraction of the whole application or part of it. The palette may contain entities that represent visual entities such as page, view, input box, entry field etc. as well as “business logic” entities that encapsulate logic execution, such as data manipulation. Entities on the editor canvas are normally connected using link lines that may represent application control flow, data flow etc. The visual application creation tool may create the software application for the programmer.

FIG. 1, to which reference is now made, illustrates a simple, exemplary catalog program designed in a visual application creation tool, such as WebSphere Studio Visual Application Builder, available from International Business Machines, Inc. of the USA. The catalog program is a website at which an application user may search a book catalog for a set of books by providing a keyword that will be searched in the titles of the books in the catalog.

As can be seen in FIG. 1, the catalog program has an entry point 10, a fill book list entity 12, a books entity 14 and a search entity 16. Execution may start at entry point 10. Fill book list entity 12 may be a business logic entity which may retrieve book data from a database. Search entity 16 may be a business logic entity which may retrieve the list of books in the database having the title input into a search entry of books entity 14. Books entity 14 may be a web page entity which may list the search result generated by search entity 16 and may display a search entry field.

To set up the application, the programmer may select the type of each entity to be utilized and may define how the entity is to operate. This may involve defining the program variables, defining how they change, what data they access and the operations they are to perform. Once this is done, the visual application creation tool may generate the software code for the catalog application.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a screen illustration of an editor of a prior art, visual application creation tool and a simple, exemplary catalog program designed therein;

FIG. 2 is a screen illustration of a visual design application editor having a data source entity type on the palette, constructed and operative in accordance with the present invention, and an exemplary catalog program designed therein;

FIGS. 3, 4, 5, 6 and 7 are screen illustrations of an exemplary design process to generate the catalog application of FIG. 2; and

FIG. 8 is a flow chart illustration of an exemplary process for providing data source entities and data links within a visual application creation tool.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In accordance with a preferred embodiment of the present invention, the palette of entities for a visual application creation tool may include data entities, allowing the developer to drag and drop data elements on the canvas. Data entities on the canvas may show a different icon for each source type, e.g., a table for a relational database, a cogwheel for Web service, a coffee bean for a Java Bean, etc.

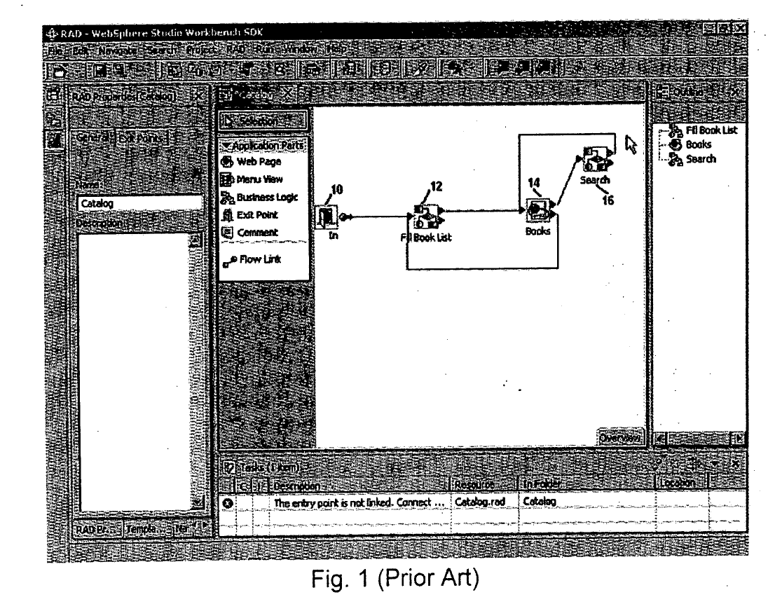

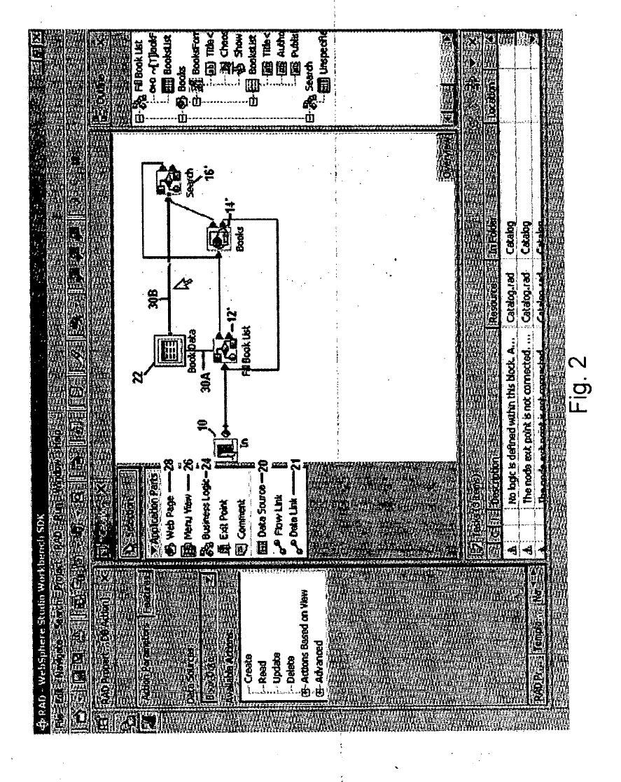

Reference is now made to FIG. 2, which illustrates a visual design application editor having a data source entity type 20 on the palette, constructed and operative in accordance with the present invention. FIG. 2 also illustrates the implementation of data source entity 20 as a book data entity 22 in the exemplary catalog application of FIG. 1. The catalog application of FIG. 2 may contain the same elements, but they may operate slightly differently than in the prior art. Therefore, they are labeled with an apostrophe ('). Thus, the catalog application of FIG. 2 may additionally comprise entry point 10, fill book list entity 12′, books entity 14′ and search entity 16′.

In accordance with one embodiment of the present invention, the developer may select a data entity 20 and may connect it, using a data link entity 21, to non-data-source entities (be they business logic nodes (entity 24), view nodes (entity 26), web page nodes (entity 28) or any other entity) on the canvas. The semantics of the data link(s), such as exemplary data links 30A and 30B, may be defined by the tool. Each data link 30 may visually represent the data access of the non-data-source entity to the data source and may represent a specific action or code within the connected, non-data-source entity that may act on data entity 20. Data link 30 may further be specialized to visualize different data manipulation operations (e.g., a blue line for a read operation and a red line for a write operation). The developer may further configure the data entities and data links using other methods (e.g., fill in database parameters such as developer-name and password in a pop-up dialog or in a properties sheet).

For example, a data link of a data source entity to a business logic entity may signify the business logic action that performs an SQL query within the business logic entity. It may be configured by editing the properties of the data link, and may be colored blue to indicate a READ operation.

In the example of FIG. 2, data link 30A may be a READ action, reading book data entity 22 in order to fill the book list. Data link 30B may also be a READ action, reading book data entity 22 with the desired search condition (for the books whose title includes the input string).

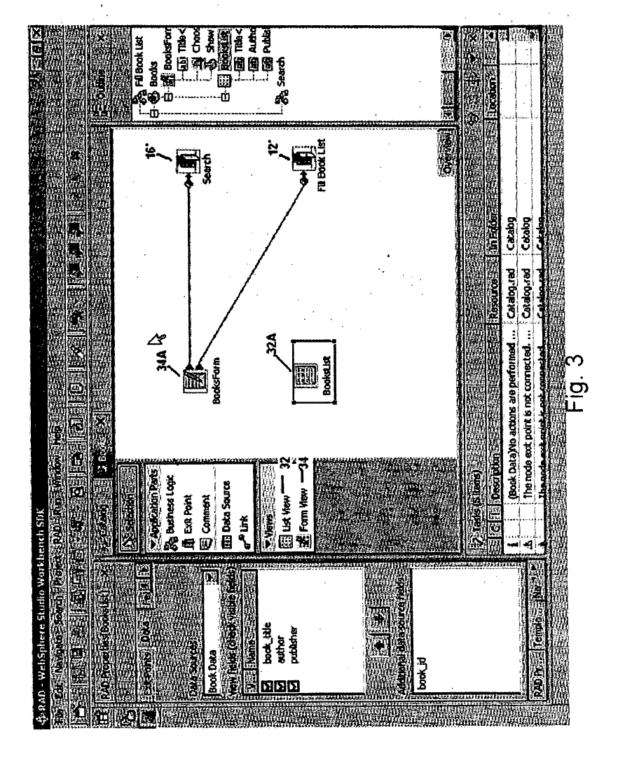

Reference is also made to FIGS. 3-7, which together illustrate an exemplary design process to generate catalog application of FIG. 2.

Before defining the two READ actions, the developer may define the presentation of the data in Books webpage 14′. This is shown in FIG. 3. Books webpage 14′ may comprise various views. For example, FIG. 3 shows that the possible views for this example include a list view 32A and a form view 34A and that both types of views, BooksForm 34A and BooksList 32A, are included in Books webpage 14′. BooksForm 34A may enable users to search the list and may show the results. Thus, BooksForm 34A may be connected to search entity 16′. BooksForm 34 may also enable users to fill BooksList 32A with all the books in the catalog and thus, may be connected to Fill Book List entity 12′. BooksList 32A may display catalog book records.

In order to define BooksList 32A, the developer may define data source entity, BookData 22, and may define the data source it refers to, such as a specific database, and its contents (e.g. fields). Afterward, the developer may select the fields of BookData 22 that s/he desires to have in BooksList 32A.

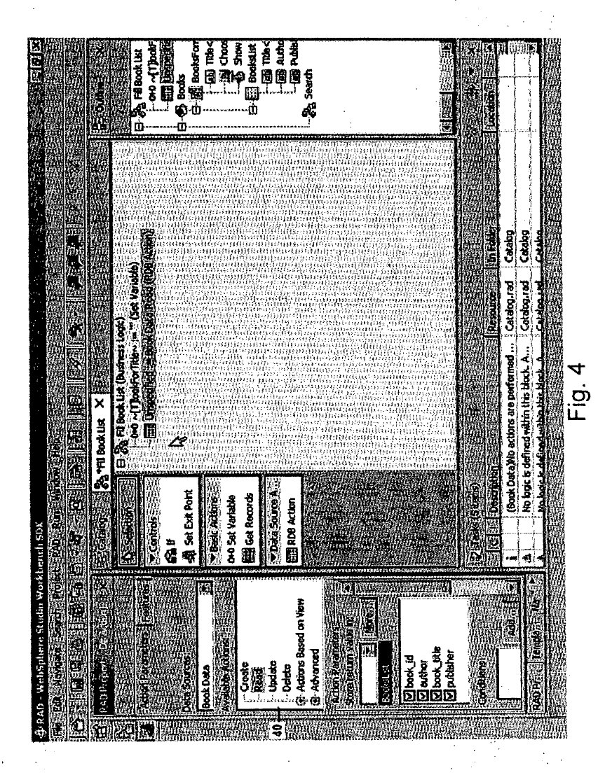

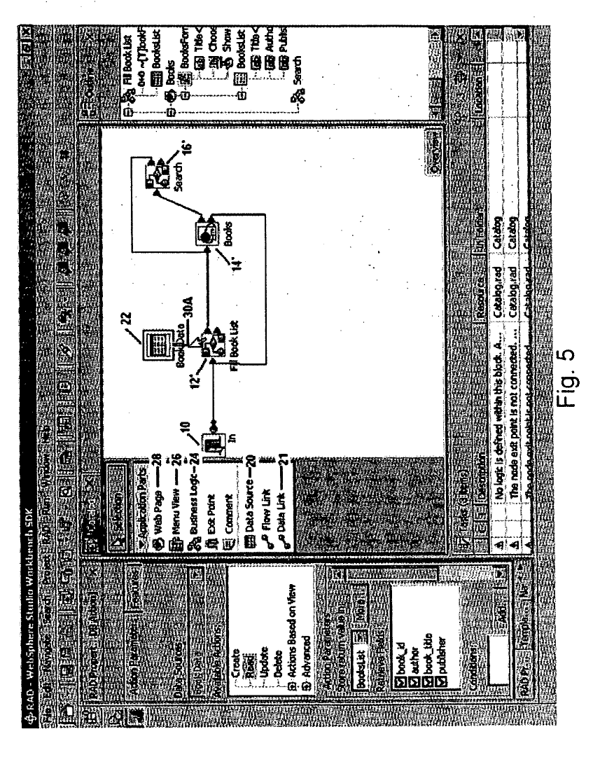

The developer may now define the operation of fill book list entity 12′. An exemplary operation, reading from BookData 22, is shown in FIG. 4. In a window 40, the tool may list the available data actions, such as READ, CREATE, UPDATE AND DELETE, the action parameters and the conditions of the action. In this example, the developer may select the READ action, may define the return variable as BooksList 32A, and may define the action as reading four fields, book_id, author, book_title and publisher. BookData 22 may now show up in the main application view of FIG. 2 with data link 30A, the above READ operation, defined. This is shown in FIG. 5.

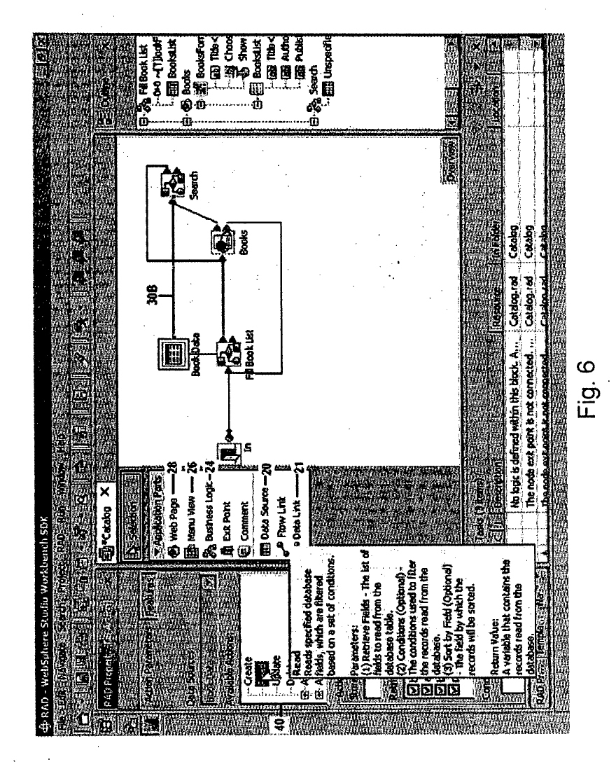

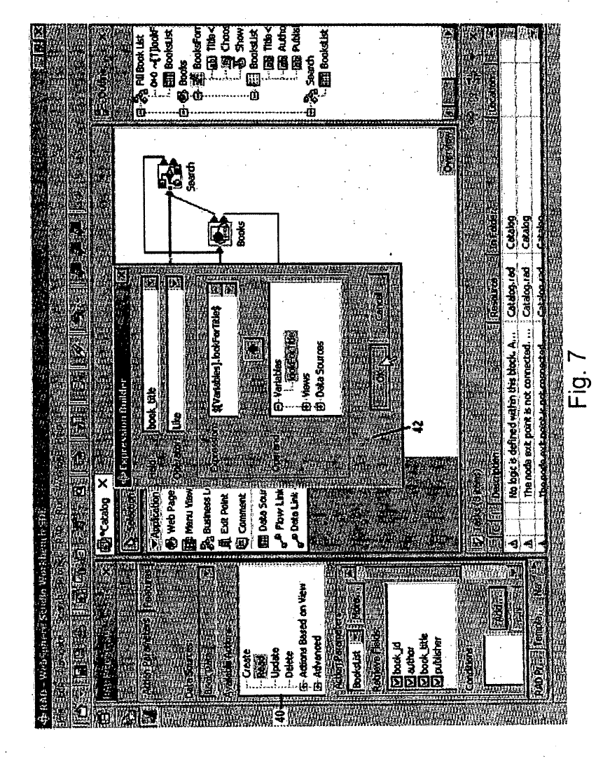

To search through the book records, the developer may define READ operation 30B by linking BookData 22 to Search entity 16′ (FIG. 6). When the developer selects the data link, the tool may bring him to window 40 in order to define READ operation 30B. As shown in FIG. 6, the process may include defining the action as a READ operation on the four fields of BooksList 32A. The process may additionally include defining the condition of the read (FIG. 7), such as through a condition dialog 42 that utilizes the input of the search entry field of BooksForm 34A.

It will be appreciated that data link 30 may be generated when defining the operations of a non-data-source entity on a data source, as shown for operation 30A, or when linking the data source entity to a non-data-source entity, as shown for operation 30B. It will also be appreciated that the data operations indicated by data links 30 form part of the internals of the non-data-source entities and are not part of the data source entity 20.

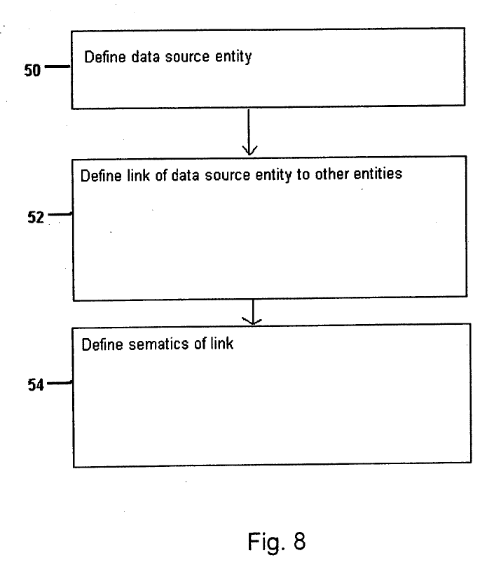

Reference is now made to FIG. 8, which illustrates, in flow chart format, an exemplary process for providing data source entities 20 and data links 21 within a visual application creation tool. In step 50, a tool developer may define the data source entity type. This may involve providing dialogs to define the type of data (database, Java Bean, Web Service, Microsoft Excel spreadsheet, etc.), its location on the computer system, its properties (such as a password), the fields or variables it stores and their properties, if necessary. It may also involve defining how the data source entity may be selected from the tool and in which views or parts of the tool it may be seen.

In step 52, the tool developer may define data links 21. This may involve defining how such data links are shown in the various views (which color to represent which action, etc.), and what happens when a user selects a data link.

In step 54, the tool developer may define the semantics for the actions indicated by data links 21. This may involve defining windows, dialog boxes or any other means to define the operations, the variables they operate on and the conditions on the operations. It may further involve defining the code behind each operation and how that code is added to the non-data-source entity to which the data source entity is linked.

In order to maintain consistency, the tool developer may define how a data link may be added when code that represents an action is added to a non-data-source entity.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method comprising:
having a data -source entity type in a visual application creation tool, said data source being associatable with a data source;
having a data link entity type in said tool; and
having indications of the type of operation to be performed by a data link entity when said data link entity connects said data source entity to at least one non-data-source entity.

2. The method of claim 1 and wherein said data link entity is capable of representing a portion of internal operations of said non-data-source entity.

3. The method of claim 1 and wherein said data source is any of the following sources: a database, a Web service, a Java Bean, and a spreadsheet.

4. The method of claim 3 and wherein said data source entity comprises a visual representation of the type of data source with which it is associated.

5. The method according to claim 4 and wherein said visual representation is an icon.

6. The method of claim 1 and wherein said indications are coded with a visual clue.

7. The method of claim 1 and wherein said type of operation is a data manipulation operation supported by said data source.

8. The method of claim 1 and wherein said data manipulation operation is any of the following operations; read, create, update and delete.

9. A method comprising:
within a visual application creation tool, providing a visual representation of data sources and of access to said data sources.

10. The method of claim 9 and wherein said providing comprises:
defining a plurality of selectable data source entity types;
defining a plurality of selectable data link entity types;
for each data link entity type, defining semantics for the actions associated therewith.

11. The method of claim 10 and wherein said data source entity types are of the following data sources; a database, a Web service, a Java Bean, and a spreadsheet.

12. The method of claim 12 and wherein each said data source entity comprises a visual representation of the type of data source with which it is associated.

13. The method of claim 12 and wherein said visual representation is an icon.

14. The method of claim 10 and also comprising defining indications of the type of operation to be performed by each data link entity when said data link entity connects a data source entity to at least one non-data-source entity.

15. The method of claim 14 and wherein said indications are visually coded.

16. The method of claim 14 and wherein said type of operation is a data manipulation operation supported by said data source.

17. The method of claim 16 and wherein said data manipulation operation is one of the following operations: read, create, update and delete.

18. A computer product readable by a machine, tangibly embodying a program of instructions executable by the machine to perform method steps, said method steps comprising:
within a visual application creation tool, providing a visual representation of data sources and of access to said data sources.

19. The product of claim 18 and wherein said providing comprises:
defining a plurality of selectable data source entity types;
defining a plurality of selectable data link entity types;
for each data link entity type defining semantics for the actions associated therewith.

20. The product of claim 19 and wherein said data source entity types are of the following data sources, a database, a Web service, a Java Bean, and a spreadsheet.

21. The product of claim 21 and wherein each said data source entity comprises a visual representation of the type of data source with which it is associated.

22. The product of claim 21 and wherein said visual representation is an icon.

23. The product of claim 19 and also comprising defining indications of the type of operation to be performed by each data link entity when said data link entity connects a data source entity to at least one non-data-source entity.

24. The product of claim 23 and wherein said indications are visually coded.

25. The product of claim 23 and wherein said type of operation is a data manipulation operation supported by said data source.

26. The product of claim 25 and wherein said data manipulation operation is one of the following operations: read, create, update and delete.
